(19) United States
(12) Patent Application Publication
(10) Pub. No.: US 2023/0202043 A1
(43) Pub. Date: Jun. 29, 2023

(54) METHOD AND SYSTEM OF ROBOTIC ARM SAFETY DETECTION BASED ON ETHERCAT AUTOMATION

(71) Applicant: University of Science and Technology Beijing, Beijing (CN)

(72) Inventors: Lun XIE, Beijing (CN); Yulin ZHOU, Beijing (CN)

(73) Assignee: University of Science and Technology Beijing, Beijing (CN)

(21) Appl. No.: 17/692,200

(22) Filed: Mar. 11, 2022

(30) Foreign Application Priority Data
Dec. 24, 2021 (CN) 202111604221.6

(51) Int. Cl. B25J 9/16

(52) U.S. Cl. CPC B25J 9/1674; B25J 9/163; G05B 2219/31145; G05B 2219/39001; G05B 2219/50193

(57) ABSTRACT

A method and system of robotic arm safety detection based on EtherCAT automation are provided. The method includes: issuing a control data through the protocol module to control the robotic arm to complete an automation operation process by the control system module, and receiving joint data fed back in real-time of the sensor module; acquiring a real-time data of the robotic arm by the data capture module; wherein the real-time data includes protocol data and joint data; the joint data is acquired by the data capture module through the sensor module; performing a protocol data rule matching and physical process detection by the intrusion detection module based on the real-time data, and obtaining an intrusion detection result; wherein the intrusion detection result is configured to detect whether an intrusion behavior occurs during a normal operation of the robotic arm.

### CROSS-REFERENCE TO RELATED APPLICATIONS

This application is based upon and claims priority to Chinese Patent Application No. 202111604221.6, filed on Dec. 24, 2021, the entire contents of which are incorporated herein by reference.

### TECHNICAL FIELD

The present disclosure relates to the technical field of safety detection of industrial robotic arms, in particular to a method and system of robotic arm safety detection based on EtherCAT automation.

### BACKGROUND

In the global smart manufacturing industry, industrial robotic arms play an increasingly important role, and have spread across various smart factories, such as automobile assembly, industrial welding, and parts selection, even China's space station is also equipped with robotic arm systems. Industrial robotic arms have become an indispensable part of the industrial field, because they cannot only improve production efficiency, but also reduce the error rate of work. And the number of industrial robotic arms is increasing year by year, and there is a lot of room for development.

Traditional robotic arm systems are only used in closed work environments, because traditional industrial equipment is mainly operated by workers or only acts on independent workbenches. With the development of communication networks and related hardware, the current robotic arm system has begun to form a network to form a smart factory, the entire production process relying on robotic arms is becoming more and more open, and it is gradually connected to the external network to form CPSs (Cyber-Physical-Social Systems, social physical information system), which can monitor and intelligently operate the production situation and data of the factory, which facilitates the industrialization process.

### SUMMARY

In one aspect, the present disclosure provides a method of robotic arm safety detection based on EtherCAT automation, wherein the method is implemented by a robotic arm safety detection system based on EtherCAT automation, the system includes a control system module, a protocol module, a sensor module, a data capture module, an intrusion detection module, and a remote log module; the method includes:

issuing a control data through the protocol module to control the robotic arm to complete an automation operation process by the control system module, and receiving joint data fed back in real-time of the sensor module;

acquiring a real-time data of the robotic arm by the data capture module; wherein the real-time data includes protocol data and joint data; the joint data is acquired by the data capture module through the sensor module;

performing a protocol data rule matching and physical process detection by the intrusion detection module based on the real-time data, and obtaining an intrusion detection result; wherein the intrusion detection result is configured to detect whether an intrusion behavior occurs during a normal operation of the robotic arm; and

completing a log recording and response work after the intrusion behavior occurs during the operation of the robotic arm by the remote log module based on the intrusion detection result.

In some embodiments, the intrusion detection module includes a protocol intrusion detection module and a physical process intrusion detection module;

performing a protocol data rule matching and physical process detection by the intrusion detection module based on the real-time data, and obtaining an intrusion detection result includes:

inputting the protocol data of the real-time data into the protocol intrusion detection module to detect whether the intrusion behavior of the Ethernet control automation technology EtherCAT protocol data occurs during the operation of the robotic arm; and

inputting the joint data of the real-time data into the physical process intrusion detection module to detect whether intrusion behavior occurs in the physical process during the operation of the robotic arm.

In some embodiments, an establishing process of the protocol intrusion detection module includes:

acquiring the protocol data under a normal operation state of the robotic arm;

performing a feature extraction on the protocol data; and

establishing a whitelist rule base based on the protocol data after the feature extraction, and obtaining a protocol intrusion detection module.

In some embodiments, inputting the protocol data of the real-time data into the protocol intrusion detection module to detect whether the intrusion behavior of the Ethernet control automation technology EtherCAT protocol data occurs during the operation of the robotic arm includes:

inputting the protocol data of the real-time data into the protocol intrusion detection module, and determining whether the real-time data conforms to the whitelist rule base, if the real-time data conforms to the whitelist rule base, determining the intrusion behavior of the EtherCAT protocol data not occurs during the operation of the robotic arm, and if the real-time data does not conform to the whitelist rule base, determining the intrusion behavior of the EtherCAT protocol data occurs during the operation of the robotic arm.

In some embodiments, the establishing process of the physical process intrusion detection module includes:

obtaining a kinematics and dynamics parameters of the robotic arm in a normal operation state;

establishing a data set based on the kinematic and kinetic parameters; and

training a machine learning model based on the data set, and classifying the operating state of the robotic arm by the machine learning model, thereby determining whether the operating state is abnormal, and obtaining a physical process intrusion detection module; wherein, the operating state includes an initialization state, a direction grasping point operating state, grasping state, direction placing point operating state, and placing state.

In some embodiments, inputting the joint data of the real-time data into the physical process intrusion detection module to detect whether intrusion behavior occurs in the physical process during the operation of the robotic arm includes:

inputting the joint data of the real-time data into the physical process intrusion detection module, and determining whether the operating state of the robotic arm at any moment is connected with the operating state of a previous moment or the operating state has not changed during the operation process of the robotic arm, if the operating state at any moment is connected with the operating state at the previous moment or the operating state has not changed, determining the physical process does not have an intrusion behavior during the operation of the robotic arm, if the operating state at any moment is not connected with the operating state at the previous moment and the operating state has changed, determining the physical process has an intrusion behavior during the operation of the robotic arm.

In some embodiments, the completing the log recording and response work after the intrusion behavior occurs during the operation of the robotic arm by the remote log module based on the intrusion detection result includes:

when the intrusion detection result is that the intrusion behavior occurs during a normal operation of the robotic arm, the remote log module feeds back the abnormal data of the intrusion behavior to a security officer host, and the security officer host issues a shutdown instruction to the control system module, and constructs an abnormal log file according to the abnormal data.

In another aspect, the present disclosure further provides a system of robotic arm safety detection based on EtherCAT automation, wherein the system is configured to realize the robotic arm safety detection method based on EtherCAT automation, the system includes a control system module, a protocol module, a sensor module, a data capture module, an intrusion detection module, and a remote log module; wherein:

the control system module is configured to issue a control data through the protocol module to control the robotic arm to complete an automation operation process, and receives joint data fed back in real time by the sensor module;

the protocol module is configured to transmit a data between the control system module and the sensor module;

the sensor module is configured to acquire a joint data fed back in real-time;

the data capture module is configured to acquire a real-time data of the robotic arm; wherein the real-time data includes protocol data and joint data; the joint data is acquired by the data capture module through the sensor module;

the intrusion detection module is configured to perform a protocol data rule matching and physical process detection, and obtain an intrusion detection result; wherein the intrusion detection result is configured to detect whether an intrusion behavior occurs during a normal operation of the robotic arm; and

the remote log module is configured to complete a log recording and response work after the intrusion behavior occurs during the operation of the robotic arm based on the intrusion detection result.

In some embodiments, the intrusion detection module includes a protocol intrusion detection module and a physical process intrusion detection module;

the intrusion detection module is further configured for:

inputting the protocol data of the real-time data into the protocol intrusion detection module to detect whether the intrusion behavior of the Ethernet control automation technology EtherCAT protocol data occurs during the operation of the robotic arm; and

inputting the joint data of the real-time data into the physical process intrusion detection module to detect whether intrusion behavior occurs in the physical process during the operation of the robotic arm.

In some embodiments, the intrusion detection module is further configured for:

acquiring the protocol data under a normal operation state of the robotic arm;

performing a feature extraction on the protocol data; and

establishing a whitelist rule base based on the protocol data after the feature extraction, and obtaining a protocol intrusion detection module.

In some embodiments, the intrusion detection module is further configured for:

inputting the protocol data of the real-time data into the protocol intrusion detection module, and determining whether the real-time data conforms to the whitelist rule base, if the real-time data conforms to the whitelist rule base, determining the intrusion behavior of the EtherCAT protocol data not occurs during the operation of the robotic arm, and if the real-time data does not conform to the whitelist rule base, determining the intrusion behavior of the EtherCAT protocol data occurs during the operation of the robotic arm.

In some embodiments, the intrusion detection module is further configured for:

obtaining a kinematics and dynamics parameters of the robotic arm in a normal operation state;

establishing a data set based on the kinematic and kinetic parameters; and

training a machine learning model based on the data set, and classifying the operating state of the robotic arm by the machine learning model, thereby determining whether the operating state is abnormal, and obtaining a physical process intrusion detection module; wherein, the operating state includes an initialization state, a direction grasping point operating state, grasping state, direction placing point operating state, and placing state.

In some embodiments, the intrusion detection module is further configured for:

inputting the joint data of the real-time data into the physical process intrusion detection module, and determining whether the operating state of the robotic arm at any moment is connected with the operating state of a previous moment or the operating state has not changed during the operation process of the robotic arm, if the operating state at any moment is connected with the operating state at the previous moment or the operating state has not changed, determining the physical process does not have an intrusion behavior during the operation of the robotic arm, if the operating state at any moment is not connected with the operating state at the previous moment and the operating state has changed, determining the physical process has an intrusion behavior during the operation of the robotic arm.

In some embodiments, the remote log module is further configured for:

when the intrusion detection result is that the intrusion behavior occurs during a normal operation of the robotic arm, the remote log module feeds back the abnormal data of the intrusion behavior to a security officer host, and the security officer host issues a shutdown instruction to the control system module, and constructs an abnormal log file according to the abnormal data.

In some embodiments, the present disclosure is applicable to all industrial robotic arm operating environments, and the EtherCAT protocol is used to ensure a real-time and reliable data transmission. The disclosure embeds the intrusion detection system into the whole operation system of the robotic arm, and can detect the intrusion without affecting the normal operation of the robotic arm and the real-time performance of the system. The intrusion detection system of the present disclosure includes the intrusion detection of the protocol and the physical process of the mechanical arm, and constitutes a surface defense, which is more effective than point defense, and can effectively detect hidden attacks. During the assembly line operation of the robotic arm, the operation safety of the robotic arm is protected and the safety of the system is improved. The disclosure adopts the EtherCAT protocol as the data transmission protocol, the topology structure is flexible, and equipment can be added or removed at any moment without affecting the functionality of the entire system. The disclosure realizes the concealed attack detection on the mechanical arm system, and improves the security and stability of the system.

### BRIEF DESCRIPTION OF THE DRAWINGS

In order to more clearly illustrate the technical solution in embodiments of the present disclosure or the prior art, the accompanying drawings which need to be used in the description of the embodiments or the prior art will be introduced briefly below. Apparently, the accompanying drawings described below are merely some embodiments of the present disclosure, and those of ordinary skill in the art can also obtain other accompanying drawings according to these drawings without making creative efforts.

FIG. 1 is a schematic flow chart of a robotic arm safety detection method based on EtherCAT automation of the present disclosure;

FIG. 2 is a framework diagram of a physical platform of the present disclosure;

FIG. 3 is a control flow chart of a ROS control system module of the present disclosure;

FIG. 4 is a working schematic diagram of a data capture module of the present disclosure;

FIG. 5 is a working flow chart of the EtherCAT protocol intrusion detection of the present disclosure;

FIG. 6 is a working flow chart of the physical process intrusion detection of the mechanical arm of the present disclosure;

FIG. 7 is a principle diagram of the remote log module of the present disclosure; and

FIG. 8 is a block diagram of a robotic arm safety detection system based on EtherCAT automation of the present disclosure.

### DETAILED DESCRIPTION OF THE EMBODIMENTS

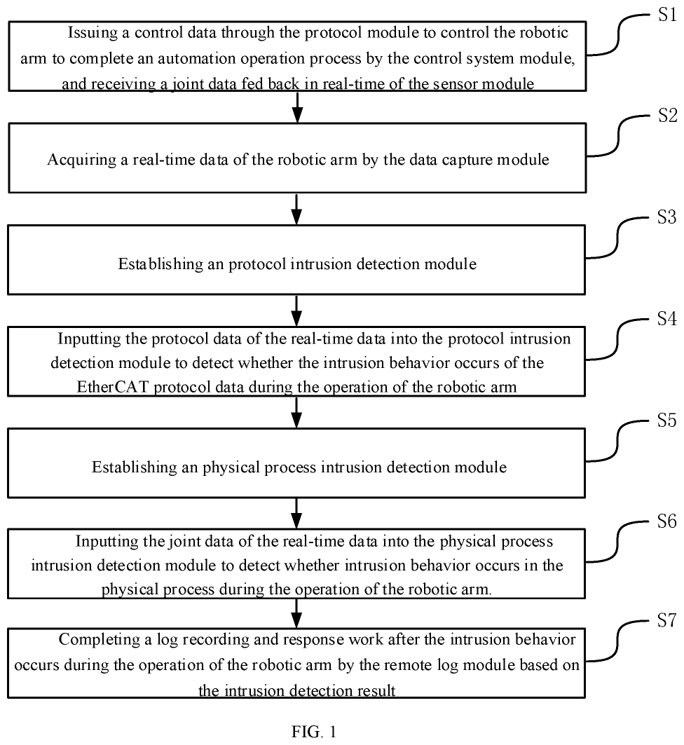

As shown in FIG. 1, the present disclosure provides a robotic arm safety detection method based on EtherCAT automation, and the method can be implemented by a robotic arm safety detection system based on EtherCAT automation. As shown in FIG. 1, a schematic flow chart of a robotic arm safety detection method based on EtherCAT automation, the processing flow of the method may include the following steps from S1 to S7:

S1, issuing a control data through the protocol module to control the robotic arm to complete an automation operation process by the control system module, and receiving joint data fed back in real-time of the sensor module;

In some embodiments, a software platform and a hardware platform are used when the robotic arm 205 completes the automation operation process, and the software platform is realized by relying on the hardware platform.

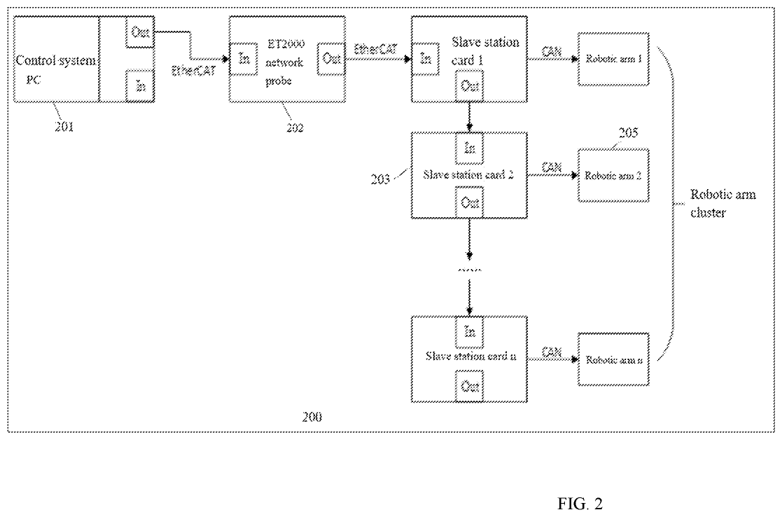

1) As shown in FIG. 2, the hardware platform 200 mainly includes: control system PC 201 (Personal Computer), ET2000 network probe 202, EtherCAT (Ethe Control Automation Technology) slave station card 203 and actuator 204.

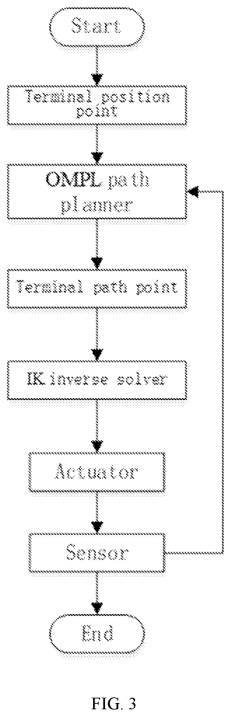

\textcircled{1} The control system PC 201 can use a desktop computer; the CPU can use Intel i5-7500; the memory can be 32 GB, 64-bit operating system; the ubuntu16.04 system equipped with Linux is used to control the operation of the system module and the operating environment of the underlying communication. The control system PC 201 is configured to install ROS (Robot Operating System), ROS can perform motion planning tasks of the robotic arm 205, and ROS has the EtherCAT soft master station communication function, which can ensure the sending and receiving of control data and sensor data, thereby ensuring the reliable operation of the robotic arm. As shown in FIG. 3, ROS includes rviz three-dimensional visualization interface, MoveIt configuration package, configuration layer and information transmission layer. The three-dimensional visualization interface is used for the display of the robotic arm model and the configuration of various plug-ins; the MoveIt configuration package provides an API (Application Programming Interface) for the motion planning of the robotic arm to realize the development of specific tasks; the configuration layer of ROS can be used to configure the parameter server of ROS and the joint characteristic parameter data of the robotic arm; the information transmission layer relies on the EtherCAT protocol in the present disclosure to configure the link library of the soft master into the function package of ROS, and the function package includes robotic arm control program.

The steps for ROS to control the robotic arm to complete the automation operation process may include: according to the requirements of the operation process, collecting the terminal position points corresponding to the three-dimensional space points that must be reached during the operation of the robotic arm, and the terminal position point corresponding to the three-dimensional space point that must be reached is regarded as the target point of the robotic arm; the planner performs path planning according to the target point and the sensor data collected by the sensor module received by the monitor, after finding the optimal path, substitute the path points in the optimal path into the inverse solver to solve the motion parameters of each joint, and send the motion parameters to the actuator, which controls each joint of the robotic arm to move according to the received motion parameters.

In some embodiments, the above-mentioned inverse solver may be a self-written IK (Inverse Kinematics) inverse solver, and the planner may be an OMPL (The Open Motion Planning Library, an open source robot motion planning library based on a sampling method) planner.

\textcircled{2} The ET2000 network probe can use products of Beckhoff, with 8 ports and 4 channels, the delay is less than 1 μs, the accuracy of the time stamp is 1 ns, the allowable ambient temperature range during operation is from 0° C. to +55° C., and the speed of the probe port can reach 100 MBit/s; the ET2000 network probe is configured to capture the protocol data packets, and its position in the physical platform is between the control system PC and the EtherCAT slave station card, while capturing data packets, it will not affect the data transmission rate, and will not affect the function of the entire system.

\textcircled{3} The processor of the EtherCAT slave station card can use the STM32F407ZET6 of the Arm Cortex-M3 framework, and the chip of the EtherCAT slave station card can use the LAN9252, which is configured to receive the control data sent by the soft master and convert the control data into CAN (Controller Area Network) data to control the robotic arm, the processor of STM32F407ZET6 is configured to control the data forwarding of slave station card, and the LAN9252 is configured to unload and load EtherCAT data. The soft master station is connected to the network probe through a network cable, and the network probe is connected to the slave station card through a network cable, the data transmission in the above process is completed through the EtherCAT protocol.

\textcircled{4} The actuator is configured to complete the operation task of the physical space, according to the instructions issued by the control system module, the movement is completed in accordance with the specified sequence of operations. The actuator is composed of seven servo motors and terminal paws, the seven servo motors are distributed on the seven joints of the robotic arm to drive the corresponding connecting rods to move, and the terminal paws controls two knuckles through two servos to grab items, and the above combination completes the complete task.

The control system PC, ET2000 network probe and the EtherCAT slave station card are connected by ultra-six gigabit Ethernet cables, and the “out” interface of the upstream device is connected to the “in” interface of the downstream device, which is connected in series. The soft master station issues the control data, and each slave station card only unloads its corresponding data from the data packet of the control data, and converts the corresponding data into CAN data, so as to control the movement of the robotic arm to complete the task, each slave station card is loaded with sensor data that needs to be uploaded, after uploading to the soft master station, the soft master station will unload the sensor data.

2) The software platform mainly includes: control system module, protocol module, sensor module, data capture module, intrusion detection module and remote log module.

\textcircled{1} The control system module is mainly configured to plan the path trajectory in the automatic operation process of the robotic arm, and receive the joint data fed back by the sensor module in real-time, and send the calculated control instructions to the slave card through the EtherCAT protocol, and then control the operation of the robotic arm to complete the entire operation process.

\textcircled{2} the protocol module is configured to transmit a data between the control system module and the sensor module, adopting EtherCAT protocol, the structure of this protocol is master-slave station mode, with high real-time and reliability.

\textcircled{3} The sensor module is configured to collect joint data of each joint in real-time, including joint angle data and joint speed data, and feed it back to the control system module. The sensor adopts an absolute encoder with an accuracy of 0.005°.

S2, the data capture module is configured to acquire a real-time data of the robotic arm;

the real-time data includes protocol data and joint data; the joint data is acquired by the data capture module through the sensor module;

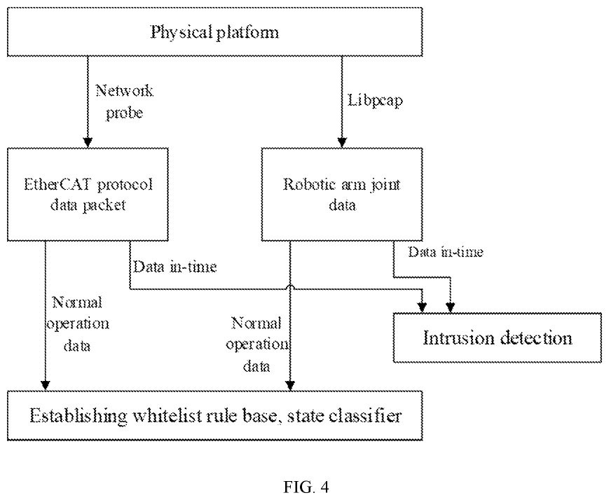

In some embodiments, as shown in FIG. 4, the data capture module is mainly divided into two sub-modules, which are an EtherCAT protocol data packet capture sub-module and a robotic arm joint data capture sub-module respectively. The EtherCAT protocol data packet capture sub-module is implemented by the ET2000 network probe, the ET2000 is placed between the soft master station and the slave station card to capture the protocol data packets. The joint data capture sub-module of the robotic arm captures the joint data through the Libpcap function, the joint data is captured through the Libpcap function when the sensor data is fed back to the control system module.

S3, establishing a protocol intrusion detection module;

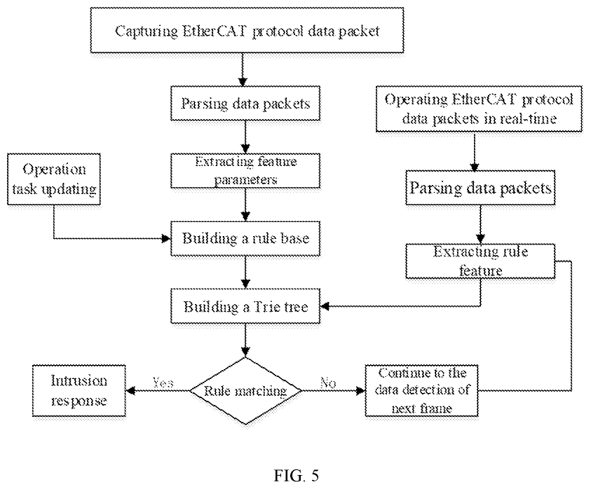

In some embodiments, as shown in FIG. 5, the above step S3 may include the following steps from S31 to S33:

S31, acquiring the protocol data under a normal operation state of the robotic arm;

In some embodiments, the EtherCAT protocol data packets in the normal operation state of the robotic arm are captured by the ET2000 placed between the soft master station and the slave station card, and then the protocol data in the normal operation state of the robotic arm is obtained.

S32, performing a feature extraction on the protocol data; and

In some embodiments, an in-depth analysis for the protocol data includes extracting key feature parameters from the protocol data in the normal operating state of the robotic arm, and further constructing the extracted key feature parameters into a tuple.

S33, establishing a whitelist rule base based on the protocol data after the feature extraction, and obtaining a protocol intrusion detection module.

In some embodiments, three types of tuples are used when constructing the whitelist rule base, namely: protocol data rule tuple, flow feature rule tuple and controller data rule tuple, wherein:

1) The protocol data rule tuple selects the destination address, source address, frame type, EtherCAT data length and EtherCAT header type in the protocol data as the rule detection content, the protocol data rule tuple is as follows: <rule ID, destination address, source address, frame type, EtherCAT data length, type>, the rule ID of the protocol data rule is set to 1.

2) In the flow feature rule tuple, the data packet size, minimum flow and maximum flow are selected as the rule detection content, the flow feature rule tuple is as follows: <rule ID, data packet size, minimum flow, maximum flow>, minimum flow and maximum flow refers to the flow per unit time, and the rule ID of the flow feature rule is set to 2.

3) In the controller data rule tuple, the address area and the three-loop PID parameter are selected as the rule detection content, the three-loop is the current loop, the speed loop and the position loop, and the rule ID of the controller data rule is set to 3. Because the robotic arm has multiple joints, each joint needs to have a controller data rule tuple, so the controller data rule tuple consists of an upper-level tuple and multiple corresponding subordinate sub-rule tuples. In some embodiments, the upper tuple is as follows: <rule_ID, address area, Joint1_ID, Joint2_ID, Joint3_ID, Joint4_ID, Joint5_ID, Joint6_ID, Joint7_ID>, Joint1_ID-Joint7_ID represents the ID number of the joint, and the sub-rule tuple corresponding to the ID number of each joint is: <Joint ID, CP, CI, CD, VP, VI, VD, PP, PI, PD>, wherein CP is the proportional parameter of the current loop, and CI is the integral parameter of the current loop, CD is the differential parameter of the current loop, VP is the proportional parameter of the speed loop, VI is the integral parameter of the speed loop, VD is the differential parameter of the speed loop, PP is the proportional parameter of the position loop, PI is the integral parameter of the position loop, and PD is the differential parameter of the position loop.

After the rule tuple is constructed, a Trie tree is established, and the Trie tree is used for subsequent rule matching detection. When the robotic arm performs an operation task, a whitelist rule base will be established according to the current operation task; when the robotic arm operation task is updated to the next operation task, a whitelist rule base will be established according to the next operation task, the whitelist rule base is updated, and the updated whitelist rule base includes the current operation task whitelist rule base and the next operation task whitelist rule base. In some embodiments, when the current robotic arm operation task is task 1, building a whitelist rule base 1, and the next robotic arm operation task is task 2, building a whitelist rule base 2, then the updated whitelist rule base includes the whitelist rule base 1 and whitelist rule base 2.

S4, inputting the protocol data of the real-time data into the protocol intrusion detection module to detect whether the intrusion behavior of the EtherCAT protocol data occurs during the operation of the robotic arm;

In some embodiments, the protocol data of the real-time data is input into the protocol intrusion detection module, determining whether the real-time data conforms to the whitelist rule base, and if the real-time data conforms to the whitelist rule base, it is determined that no intrusion behavior has occurred in the EtherCAT protocol data during the operation of the robotic arm, if the real-time data does not conform to the whitelist rule base, it is determined that the EtherCAT protocol data intrusion has occurred during the operation of the robotic arm.

In some embodiments, the protocol data of the real-time data is obtained, and the efficient pattern matching algorithm of the Trie tree established above is used to determine whether the protocol data conforms to the content of the three types of tuples in the whitelist rule base, if the protocol data belongs to the content of the three types of tuples, it is determined that the EtherCAT protocol data does not intrude during the operation of the robotic arm; if the protocol data does not belong to the content of the three types of tuples, it is determined that the EtherCAT protocol data has intrusion behavior during the operation of the robotic arm.

S5, establishing a physical process intrusion detection module;

In some embodiments, the above step S5 may include the following steps from S51 to S53:

S51, obtaining a kinematics and dynamics parameters of the robotic arm in a normal operation state;

In some embodiments, when the robotic arm is in normal operation, the Libpcap function is used to capture the joint data of the entire operation process, and after analyzing the captured joint data, the kinematics and dynamics of the robotic arm in the normal operation state are calculated, the kinematics includes the terminal position, according to the joint angle data, the forward kinematics of kinematics is used to solve the terminal position, the terminal position is represented by ₖ⁰T=₁⁰T·₁²T·₃³T· . . . ·ₖ^{k-1}T, where T is the homogeneous transformation matrix, which is calculated from the joint angle, and k is the number of position. Before calculating the dynamic parameters, a parameter identification of the robotic arm can be carried out to confirm that the parameters used in the dynamic model are correct, and then the dynamic parameters are calculated, the dynamic parameters are the torque of each joint, which can be obtained by using the Newton-Eulerian method to solve it.

It should be noted that, for the above-mentioned process of acquiring the kinematics and dynamic parameters of the robotic arm in the normal operating state, technical means commonly used in the prior art may be used, which will not be repeated here in the present disclosure.

S52, establishing a data set based on the kinematic and kinetic parameters; and

In some embodiments, the joint angle, gripper angle, joint speed, joint acceleration, and joint torque of the robotic arm are used as characteristic values, wherein the joint angle, gripper angle, joint speed, and joint acceleration are obtained through the sensor module, the joint torque is calculated from the joint angle, gripper angle, joint speed, and joint acceleration; marking the corresponding state label when saving each group of data. The dynamic parameters are added because they can better represent the motion characteristics of the robotic arm, and the accuracy of the classifier is higher. The feature data is preprocessed, invalid data is removed, and then data standardization is performed.

S53, training a machine learning model based on the data set, and classifying the operating state of the robotic arm by the machine learning model, wherein, the operating state includes an initialization state, a direction grasping point operating state, grasping state, direction placing point operating state, and placing state.

In some embodiments, a PSO SVM (Particle Swarm Optimization Support Vector Machine) model is used to train the training data set, and a trained training data set is obtained, tuning the parameters in the initial state classifier model to achieve the expected good classification effect according to the trained training data set, and the trained state classifier model is obtained. The state classifier model may be a commonly used model in the prior art, such as a decision tree model, a gradient boosting tree model, or a naive Bayesian model, which is not limited in the present disclosure.

S6, inputting the joint data of the real-time data into the physical process intrusion detection module to detect whether intrusion behavior occurs in the physical process during the operation of the robotic arm;

In some embodiments, inputting the joint data of the real-time data into the physical process intrusion detection module, and determining whether the operating state of the robotic arm at any moment is connected with the operating state of a previous moment or the operating state has not changed during the operation process of the robotic arm, if the operating state at any moment is connected with the operating state at the previous moment or the operating state has not changed, determining the physical process does not have an intrusion behavior during the operation of the robotic arm, if the operating state at any moment is not connected with the operating state at the previous moment and the operating state has changed, determining the physical process has an intrusion behavior during the operation of the robotic arm.

Wherein, any moment refers to any detection moment, and the last moment refers to the previous detection moment.

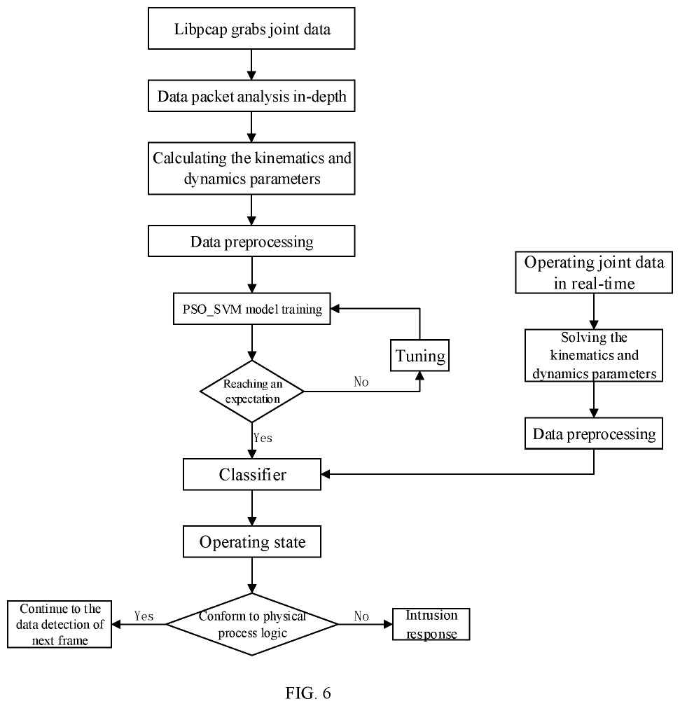

In some embodiments, as shown in FIG. 6, in the physical process intrusion detection stage, after the kinematic and dynamic parameters of the real-time joint data of the robotic arm are calculated, the characteristic data obtained by the calculation is preprocessed, and the preprocessed feature data is substituted into the state classifier model for classification, and the operating state detected at the current moment can be obtained.

Assuming that there are n operating states in total, which are represented by s₁, s₂, . . . sₘ, . . . , sₙ, the operating state detected at the current moment yᵢ is sₘ. If the operating state detected at the last moment yᵢ₋₁ is sₘ₋₁i, it means that the operating state of the robotic arm at any moment is connected with the operating state of a previous moment; if the operating state detected at the last moment yᵢ₋₁ is sₘ, it means that the operating state at the current moment is consistent with the operating state at the previous moment, that is, the operating state has not changed. In these two cases, it is determined that the physical process of the robotic arm has not an intrusion during the operation. Conversely, if the operating state detected at the last moment yᵢ₋₁ is neither sₘ₋₁ nor sₘ, determining the physical process has an intrusion behavior during the operation of the robotic arm. In some embodiments, it is assumed that the operating states may include an initialization state, a direction grasping point operating state, grasping state, direction placing point operating state, and placing state, which are arranged in sequence.

Determining whether the operating state at any moment is connected to the previous operating state, if the currently detected operating state is the direction grasping point operating state, and the operating state detected at the last time is the initialization state, then it is determined that the current operating state is connected with the operating state of a previous moment; if the currently detected operating state is the grasping state, and the operating state detected at the last moment is the direction grasping point operating state, it is determined that the operating state at the current moment is connected to the operating state at the previous moment; if the currently detected operating state is the direction placing point operating state, and the operating state detected at the previous moment is the grasping state, it is determined that the operating state at the current moment is connected to the operating state at the previous moment; if the currently detected operating state is the placing state, and the operating state detected at the last moment is the direction placing point operating state, it is determined that the operating state at the current moment is connected to the operating state at the previous moment. The operating state has not changed, which means that the currently detected operating state is consistent with the operating state detected at the last detection time, for example, if the currently detected operating state is the direction grasping point operating state, and the operating state detected at the last detection time is also the direction grasping point operating state, it is determined that the movement state has not changed. In this case, it can be determined that the physical process does not intrude during the operation of the robotic arm.

Conversely, if the currently detected operating state is the direction grasping point operating state, but the operating state detected at the last time is neither the initialization state nor the direction grasping point operating state, then it is determined that the current operating state is not connected with the operating state of a previous moment and the operating state has changed; if the currently detected operating state is the grasping state, but the operating state detected at the last moment is neither the direction grasping point operating state nor the grasping state, it is determined that the operating state at the current moment is not connected to the operating state at the previous moment and the operating state has changed; if the currently detected operating state is the direction placing point operating state, but the operating state detected at the previous moment is neither the grasping state nor the direction placing point operating state, it is determined that the operating state at the current moment is not connected to the operating state at the previous moment and the operating state has changed; if the currently detected operating state is the placing state, but the operating state detected at the last moment is neither the direction placing point operating state nor the placing state, it is determined that the operating state at the current moment is not connected to the operating state at the previous moment and the operating state has changed, it can be determined that the physical process does intrude during the operation of the robotic arm.

S7, the remote log module is configured to complete a log recording and response work after the intrusion behavior occurs during the operation of the robotic arm based on the intrusion detection result.

In some embodiments, when the result of the protocol intrusion detection and the physical intrusion detection result is that no intrusion has occurred, the robotic arm performs operations normally and continues to detect the acquired data. When any one or all of the intrusion detection results of the protocol intrusion detection result and the physical intrusion detection result are intrusion detection results, the remote log module needs to complete the response work after the intrusion behavior occurs during the operation of the robotic arm.

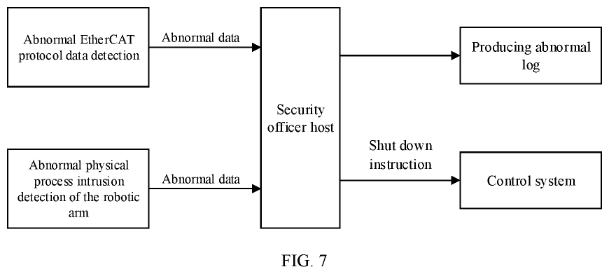

The response work after the intrusion behavior can include: as shown in FIG. 7, the remote log module 860 is mainly responsible for the intrusion response work after the robotic arm system is abnormal. When the EtherCAT protocol intrusion detection or physical process intrusion detection is abnormal, the abnormal data will be sent to the security officer host, the security officer host can be controlled by the machine or manually, when the security officer host is controlled by the machine or manually, after receiving abnormal data, firstly issue a shutdown instruction to the control system, the control system stops the robotic arm from operating to avoid irreversible damage, at the same time, an abnormal data log is generated according to the abnormal data, so that the staff can analyze the specific module of intrusion received and analyze the specific content of the abnormal data, so as to complete the system response work after the intrusion occurs. Abnormal data can be data that does not conform to the whitelist rule base, and the operating state is not connected to the operating state at the previous moment and the operating state has changed.

In some embodiments, the present disclosure is applicable to all industrial robotic arm operating environments, and the EtherCAT protocol is adopted to ensure a real-time and reliable data transmission. The present disclosure embeds the intrusion detection system into the whole operation system of the robotic arm, and can detect the intrusion without affecting the normal operation of the robotic arm and the real-time performance of the system. The intrusion detection system of the present disclosure includes the intrusion detection of the protocol and the physical process of the mechanical arm, and constitutes a surface defense, which is more effective than point defense, and can effectively detect hidden attacks. During the assembly line operation of the robotic arm, the operation safety of the robotic arm is protected and the safety of the system is improved. The present disclosure adopts the EtherCAT protocol as the data transmission protocol, the topology structure is flexible, and equipment can be added or removed at any moment without affecting the functionality of the entire system. The disclosure realizes the concealed attack detection on the mechanical arm system, and improves the security and stability of the system insertion.

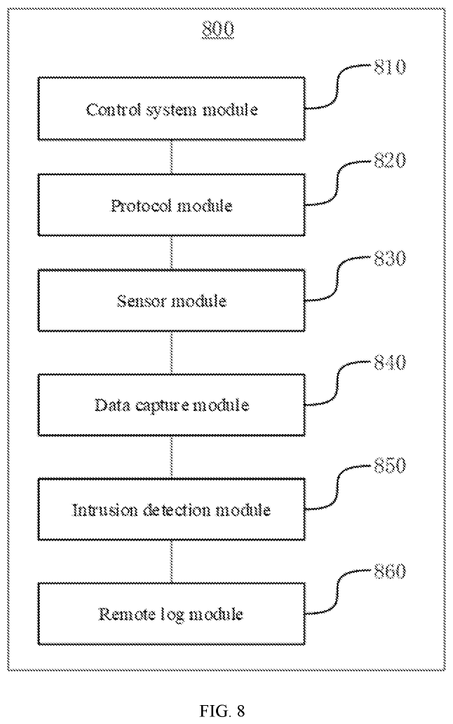

As shown in FIG. 8, the present disclosure further provides a system 800 of robotic arm safety detection based on EtherCAT automation, wherein the system 800 is configured to realize the robotic arm safety detection method based on EtherCAT automation, the system 800 includes a control system module 810, a protocol module 820, a sensor module 830, a data capture module 840, an intrusion detection module 850, and a remote log module 860; wherein:

the control system module 810 is configured to issue a control data through the protocol module to control the robotic arm to complete an automation operation process, and receives joint data fed back in real time by the sensor module;

the protocol module 820 is configured to transmit a data between the control system module and the sensor module;

the sensor module 830 is configured to acquire a joint data fed back in real-time;

the data capture module 840 is configured to acquire a real-time data of the robotic arm; wherein the real-time data includes protocol data and joint data; the joint data is acquired by the data capture module through the sensor module;

the intrusion detection module 850 is configured to perform a protocol data rule matching and physical process detection, and obtain an intrusion detection result; wherein the intrusion detection result is configured to detect whether an intrusion behavior occurs during a normal operation of the robotic arm;

the remote log module 860 is configured to complete a log recording and response work after the intrusion behavior occurs during the operation of the robotic arm based on the intrusion detection result.

In some embodiments, the intrusion detection module includes a protocol intrusion detection module and a physical process intrusion detection module;

the intrusion detection module 850 is further configured for:

inputting the protocol data of the real-time data into the protocol intrusion detection module to detect whether the intrusion behavior of the Ethernet control automation technology EtherCAT protocol data occurs during the operation of the robotic arm; and

inputting the joint data of the real-time data into the physical process intrusion detection module to detect whether intrusion behavior occurs in the physical process during the operation of the robotic arm.

In some embodiments, the intrusion detection module 850 is further configured for:

an establishing process of the protocol intrusion detection module includes:

acquiring the protocol data under a normal operation state of the robotic arm;

performing a feature extraction on the protocol data; and

establishing a whitelist rule base based on the protocol data after the feature extraction, and obtaining a protocol intrusion detection module.

In some embodiments, the intrusion detection module 850 is further configured for:

inputting the protocol data of the real-time data into the protocol intrusion detection module, and determining whether the real-time data conforms to the whitelist rule base, if the real-time data conforms to the whitelist rule base, determining the intrusion behavior of the EtherCAT protocol data not occurs during the operation of the robotic arm, and if the real-time data does not conform to the whitelist rule base, determining the intrusion behavior of the EtherCAT protocol data occurs during the operation of the robotic arm.

In some embodiments, the intrusion detection module 850 is further configured for:

obtaining a kinematics and dynamics parameters of the robotic arm in a normal operation state;

establishing a data set based on the kinematic and kinetic parameters; and

training a machine learning model based on the data set, and classifying the operating state of the robotic arm by the machine learning model, thereby determining whether the operating state is abnormal, and obtaining a physical process intrusion detection module;

wherein, the operating state includes an initialization state, a direction grasping point operating state, grasping state, direction placing point operating state, and placing state.

In some embodiments, the intrusion detection module 850 is further configured for:

inputting the joint data of the real-time data into the physical process intrusion detection module, and determining whether the operating state of the robotic arm at any moment is connected with the operating state of a previous moment or the operating state has not changed during the operation process of the robotic arm, if the operating state at any moment is connected with the operating state at the previous moment or the operating state has not changed, determining the physical process does not have an intrusion behavior during the operation of the robotic arm, if the operating state at any moment is not connected with the operating state at the previous moment and the operating state has changed, determining the physical process has an intrusion behavior during the operation of the robotic arm.

In some embodiments, the remote log module 860 is further configured for:

when the intrusion detection result is that the intrusion behavior occurs during a normal operation of the robotic arm, the remote log module feeds back the abnormal data of the intrusion behavior to a security officer host, and the security officer host issues a shutdown instruction to the control system module, and constructs an abnormal log file according to the abnormal data.

In some embodiments, the present disclosure is applicable to all industrial robotic arm operating environments, and the EtherCAT protocol is adopted to ensure a real-time and reliable data transmission. The present disclosure embeds the intrusion detection system into the whole operation system of the robotic arm, and can detect the intrusion without affecting the normal operation of the robotic arm and the real-time performance of the system. The intrusion detection system of the present disclosure includes the intrusion detection of the protocol and the physical process of the mechanical arm, and constitutes a surface defense, which is more effective than point defense, and can effectively detect hidden attacks. During the assembly line operation of the robotic arm, the operation safety of the robotic arm is protected and the safety of the system is improved. The present disclosure adopts the EtherCAT protocol as the data transmission protocol, the topology structure is flexible, and equipment can be added or removed at any moment without affecting the functionality of the entire system. The disclosure realizes the concealed attack detection on the mechanical arm system, and improves the security and stability of the system insertion.

Those of ordinary skill in the art can understand that all or part of the steps of implementing the above embodiments can be completed by hardware, or can be completed by instructing relevant hardware through a program, and the program can be stored in a computer-readable storage medium, the storage medium mentioned may be a read-only memory, a magnetic disk or an optical disk, etc.

What is described above is merely the specific embodiments of the present disclosure. However, the protection scope of the present disclosure is not limited this, and any alteration or replacement which those skilled in the art can easily think of within the technical scope disclosed by the present disclosure shall fall within the protection scope of the present disclosure. Therefore, the protection scope of the present disclosure shall be subject to the protection scope of the claims.

What is claimed is:

1. A method of a robotic arm safety detection based on an Ethernet control automation technology (EtherCAT) automation, wherein the method is implemented by a robotic arm safety detection system based on the EtherCAT automation, the robotic arm system comprises a control system module, a protocol module, a sensor module, a data capture module, an intrusion detection module, and a remote log module; the method comprises the following steps:
issuing a control data through the protocol module to control a robotic arm to complete an automation operation process by the control system module, and receiving a joint data fed back in real-time of the sensor module;
acquiring a real-time data of the robotic arm by the data capture module; wherein the real-time data comprises a protocol data and the joint data; the joint data is acquired by the data capture module through the sensor module;
performing a protocol data rule matching and a physical process detection by the intrusion detection module based on the real-time data, and obtaining an intrusion detection result; wherein the intrusion detection result is configured to detect whether an intrusion behavior occurs during a normal operation of the robotic arm; and
completing a log recording and response work after the intrusion behavior occurs during the normal operation of the robotic arm by the remote log module based on the intrusion detection result.

2. The method according to claim 1, wherein the intrusion detection module comprises a protocol intrusion detection module and a physical process intrusion detection module;
the step of performing the protocol data rule matching and the physical process detection by the intrusion detection module based on the real-time data, and obtaining an intrusion detection result comprises the following sub-steps:
inputting the protocol data of the real-time data into the protocol intrusion detection module to detect whether the intrusion behavior of EtherCAT protocol data occurs during the normal operation of the robotic arm; and
inputting the joint data of the real-time data into the physical process intrusion detection module to detect whether the intrusion behavior occurs in the physical process during the normal operation of the robotic arm.

3. The method according to claim 2, wherein an establishing process of the protocol intrusion detection module comprises the following steps:
acquiring the protocol data under a normal operation state of the robotic arm;
performing a feature extraction on the protocol data; and
establishing a whitelist rule base based on the protocol data after the feature extraction, and obtaining the protocol intrusion detection module.

4. The method according to claim 3, wherein the sub-step of inputting the protocol data of the real-time data into the protocol intrusion detection module to detect whether the intrusion behavior of the EtherCAT protocol data occurs during the normal operation of the robotic arm comprises:
inputting the protocol data of the real-time data into the protocol intrusion detection module, and determining whether the real-time data conforms to the whitelist rule base, if the real-time data conforms to the whitelist rule base, determining that the intrusion behavior of the EtherCAT protocol data does not occur during the normal operation of the robotic arm, and if the real-time data does not conform to the whitelist rule base, determining that the intrusion behavior of the EtherCAT protocol data occurs during the normal operation of the robotic arm.

5. The method according to claim 2, wherein an establishing process of the physical process intrusion detection module comprises:
obtaining kinematics and dynamics parameters of the robotic arm in a normal operation state;
establishing a data set based on the kinematics and dynamics parameters; and
training a machine learning model based on the data set, and classifying an operating state of the robotic arm by the machine learning model, thereby determining whether the operating state is abnormal, and obtaining the physical process intrusion detection module; wherein, the operating state comprises an initialization state, a direction grasping point operating state, a grasping state, a direction placing point operating state, and a placing state.

6. The method according to claim 5, wherein the sub-step of inputting the joint data of the real-time data into the physical process intrusion detection module to detect whether the intrusion behavior occurs in the physical process during the normal operation of the robotic arm comprises:
inputting the joint data of the real-time data into the physical process intrusion detection module, and determining whether the operating state of the robotic arm at any moment is connected with an operating state of a previous moment or the operating state of the robotic arm has not changed during an operation process of the robotic arm, if the operating state of the robotic arm at any moment is connected with the operating state at the previous moment or the operating state of the robotic arm has not changed, determining that the physical process does not have the intrusion behavior during the normal operation of the robotic arm, if the operating state of the robotic arm at any moment is not connected with the operating state at the previous moment and the operating state of the robotic arm has changed, determining that the physical process has the intrusion behavior during the normal operation of the robotic arm.

7. The method according to claim 1, wherein the step of completing the log recording and response work after the intrusion behavior occurs during the normal operation of the robotic arm by the remote log module based on the intrusion detection result comprises:
when the intrusion detection result is that the intrusion behavior occurs during the normal operation of the robotic arm, the remote log module feeds back an abnormal data of the intrusion behavior to a security officer host, and the security officer host issues a shutdown instruction to the control system module, and the security officer host constructs an abnormal log file according to the abnormal data.

8. A system of a robotic arm safety detection based on an Ethernet control automation technology (EtherCAT) automation, wherein the system is configured to realize a robotic arm safety detection method based on the EtherCAT automation, the system comprises a control system module, a protocol module, a sensor module, a data capture module, an intrusion detection module, and a remote log module; wherein:
the control system module is configured to issue a control data through the protocol module to control a robotic arm to complete an automation operation process, and the control system module is configured to receive a joint data fed back in real-time by the sensor module;
the protocol module is configured to transmit a data between the control system module and the sensor module;
the sensor module is configured to acquire the joint data fed back in real-time;
the data capture module is configured to acquire a real-time data of the robotic arm;
wherein the real-time data comprises a protocol data and the joint data; the joint data is acquired by the data capture module through the sensor module;
the intrusion detection module is configured to perform a protocol data rule matching and a physical process detection, and obtain an intrusion detection result; wherein the intrusion detection result is configured to detect whether an intrusion behavior occurs during a normal operation of the robotic arm; and
the remote log module is configured to complete a log recording and response work after the intrusion behavior occurs during the normal operation of the robotic arm based on the intrusion detection result.

9. The system according to claim 8, wherein the intrusion detection module comprises a protocol intrusion detection module and a physical process intrusion detection module;
the intrusion detection module is further configured for:
inputting the protocol data of the real-time data into the protocol intrusion detection module to detect whether the intrusion behavior of EtherCAT protocol data occurs during the normal operation of the robotic arm; and
inputting the joint data of the real-time data into the physical process intrusion detection module to detect whether the intrusion behavior occurs in the physical process during the normal operation of the robotic arm.

10. The system according to claim 8, wherein the remote log module is further configured for:
when the intrusion detection result is that the intrusion behavior occurs during the normal operation of the robotic arm, the remote log module feeds back an abnormal data of the intrusion behavior to a security officer host, and the security officer host issues a shutdown instruction to the control system module, and the security officer host constructs an abnormal log file according to the abnormal data.
